(19) United States
(12) Patent Application Publication
(10) Pub. No.: US 2011/0100983 A1
(43) Pub. Date: May 5, 2011

(54) POUCH EQUIPPED WITH INTERNAL PRESSURE DISCHARGE UNIT USABLE IN MICROWAVE OVEN

(75) Inventor: Yong-Kyo HAN, Seoul (KR)

(73) Assignee: Wonji Co., Ltd., Chungnam (KR)

(21) Appl. No.: 12/689,337

(22) Filed: Jan. 19, 2010

(30) Foreign Application Priority Data
Nov. 5, 2009 (KR) 10-2009-0106475

(51) Int. Cl. H05B 6/80

(52) U.S. Cl. 219/725

(57) ABSTRACT

Disclosed is a pouch equipped with an internal pressure discharge unit capable of automatically discharging gas or steam while preventing contents from being solidified. The pouch includes a sealing part formed at a side end of the pouch, a content retaining part, a sealing weak part formed at an upper portion of the sealing part, a content holding part positioned in line with the sealing weak part such that a front end of the content holding part is open when the sealing weak part is widened, and a gas discharge line formed in the content holding part and communicated with an outer end of the sealing part. The contents are prevented from being leaked out of the pouch even if the heating time is extended, and the gas is prevented from being discharged out of the pouch, thereby minimizing evaporation of moisture from the contents.

### BACKGROUND OF THE INVENTION

1. Field of the Invention

The present invention relates to a pouch equipped with an internal pressure discharge unit capable of automatically discharging gas or steam, which is generated in the pouch when contents are heated in a microwave oven. More particularly, the present invention relates to a pouch equipped with an internal pressure discharge unit capable of preventing contents from being leaked out of the pouch and preventing the contents from being solidified after heating while facilitating the manufacturing process thereof.

2. Description of the Related Art

In general, a pouch includes two vinyl sheets having the same size, in which each vinyl sheet has a multi-layer structure. The two vinyl sheets are overlapped with each other and both sides of the two vinyl sheets are sealed through a thermal bonding. A bottom part is folded inwardly at the lower end of the pouch such that the pouch can stand erect when the bottom part is expanded outwardly. Contents, such as foods, are input into the pouch through an opening formed at a top part of the pouch. The pouch is suitably used for packing instant foods adaptable for cooking in a microwave oven.

However, when the contents in the pouch are heated in the microwave oven, moisture contained in the contents may be evaporated so that gas or steam is generated in the pouch. Thus, internal pressure of the pouch is gradually increased, causing expansion of the pouch. In extreme case, the pouch may be broken. In this case, the user must adjust the internal pressure of the pouch by cutting away an upper portion of the pouch or forming pores in the pouch such that the gas or steam can be discharged from the pouch. However, such a work may cause inconvenience of the user and the contents in the pouch may be spilled from the pouch through the pores.

To solve the above problem, pouches equipped with internal pressure discharge units have been suggested, but they cause difficulty in fabrication. In most conventional pouches, the internal pressure discharge units are prepared in the form of gas discharge holes to discharge gas or steam. The gas discharge holes are useful when the heating time is short. However, if the amount of gas or steam is suddenly increased due to the extension of heating time or if the contents in the pouch are boiled with increase in volume of the contents, the contents may be leaked out of the pouch together with the gas or steam through the gas discharge holes.

In addition, since the gas is almost discharged from the pouch, the contents may be solidified after heating, thereby deteriorating the taste of the contents.

### SUMMARY OF THE INVENTION

The present invention has been made to solve the above problems occurring in the prior art, and an object of the present invention is to provide a pouch equipped with an internal pressure discharge unit usable in a microwave oven, capable of preventing contents from being leaked out of the pouch even if the heating time is extended and facilitating the manufacturing process thereof while minimizing evaporation of moisture contained in the contents.

In order to accomplish the above object, according to the present invention, a sealing weak part is protrudingly formed at a sealing part formed at a side end of a pouch such that the sealing weak part can be primarily affected by internal pressure upon expansion of the pouch, and a front end of the pouch is open in line with the sealing weak part when the sealing weak part is open, thereby discharging gas or steam.

According to the pouch equipped with the internal pressure discharge unit usable in the microwave oven, a content retaining part has a gas discharge line so that the pouch can be prevented from being broken or deformed and contents can be prevented from being leaked out of the pouch even if the heating time is extended, thereby preventing the microwave oven from being contaminated while preventing the waste of the contents. In addition, evaporation of moisture in the contents can be minimized, so that deterioration of the contents and degradation of the taste of the contents can be prevented. Further, the internal pressure discharge unit can be simply manufactured in the step of sealing the pouch.

### BRIEF DESCRIPTION OF THE DRAWINGS

The above and other advantages of the present invention will become readily apparent with reference to the following detailed description when considered in conjunction with the accompanying drawings wherein:

FIG. 1 is a perspective view illustrating a pouch according to an embodiment of the present invention;

FIG. 2 is a sectional view taken along line A-A′ of FIG. 1;

FIG. 3 is a perspective view illustrating the discharge of internal pressure in a pouch when contents contained in the pouch is heated according to the present invention; and

FIG. 4 is a sectional view taken along line B-B′ of FIG. 3.

### DESCRIPTION OF THE EMBODIMENTS

Hereinafter, exemplary embodiments of the present invention will be explained in detail with reference to the accompanying drawings.

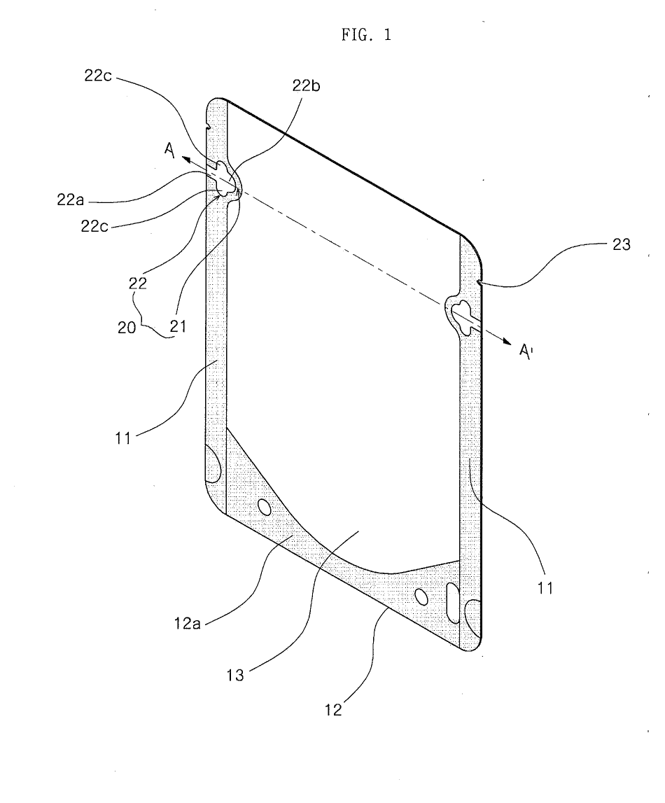

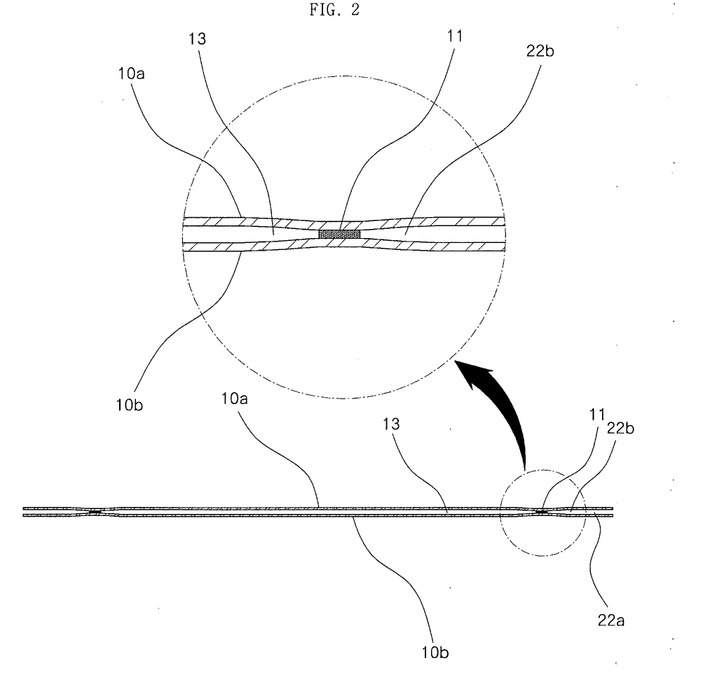

As shown in FIGS. 1 and 2, a pouch for a microwave oven includes two vinyl sheets 10a and 10b having the same size and predetermined thickness. The two vinyl sheets 10a and 10b are overlapped with each other to form front and rear surfaces of the pouch. Both sides of the vinyl sheets 10a and 10b are sealed through a thermal bonding, thereby forming sealing parts 11 at both sides of the vinyl sheets 10a and 10b. A bottom part 12 is formed at a lower portion of the sealing parts 11 through a thermal bonding. The bottom part 12 includes a bottom surface 12a which is folded inwardly such that the pouch can stand erect when the bottom surface 12a is expanded outwardly. A content retaining part 13 is defined between the sealing parts 11 and the bottom part 12. An upper portion of the content retaining part 13 is open to receive the contents therein. Internal pressure discharge units 20 are provided at both sides of the sealing parts 11, respectively. Each internal pressure discharge unit 20 includes a sealing weak part 21 which is widened when internal pressure is applied thereto upon expansion of the content retaining part 13, and a content holding part 22 formed in line with the sealing weak part 21 at a rear portion of the sealing weak part 21. A front end of the content holding part 22 is open as the sealing weak part 21 is widened, so that gas and contents are partially moved from the content retaining part 13 to the content holding part 22, thereby adjusting the internal pressure of content retaining part 13 through a gas discharge line 22a communicated with an outer end of the sealing part 11.

The sealing weak part 21 extends into the content retaining part 13 in the shape of a half-moon, and the front end of the content holding part 22 is formed at the center of the sealing weak part 21. That is, the front end of the content holding part 22 is positioned inwardly of the side end line of the content retaining part 22, so that the gas and contents can be easily moved into the content holding part 22.

A first expansion part 22b is formed at the center of the content holding part 22 such that a front end of the first expansion part 22b can protrude outward in a curved shape. In addition, a second expansion part 22c is formed at upper and lower portions of the content holding part 22 such that the second expansion part 22c can protrude outward in a curved shape. Thus, the gas and contents are distributed in the upper and lower portions of the content holding part 22, so that the internal pressure can be adjusted while minimizing the discharge of gas. As a result, the discharge of moisture from the contents can be minimized.

Therefore, when the contents held in the content holding part 22 are discharged to the outside after heating, the first and second expansion parts 22b and 22c having the curved shape may reduce the amount of contents adhering to the content holding part 22, thereby minimizing the loss of contents.

Meanwhile, a tear groove 23 is formed in at least one of the sealing parts 11 to allow the user to easily open the pouch after heating. According to the present invention, the internal pressure discharge units 20 are formed at both sealing parts 11 of the pouch, respectively. However, the internal pressure discharge unit 20 can be formed only at one sealing part 11 within the scope of the present invention.

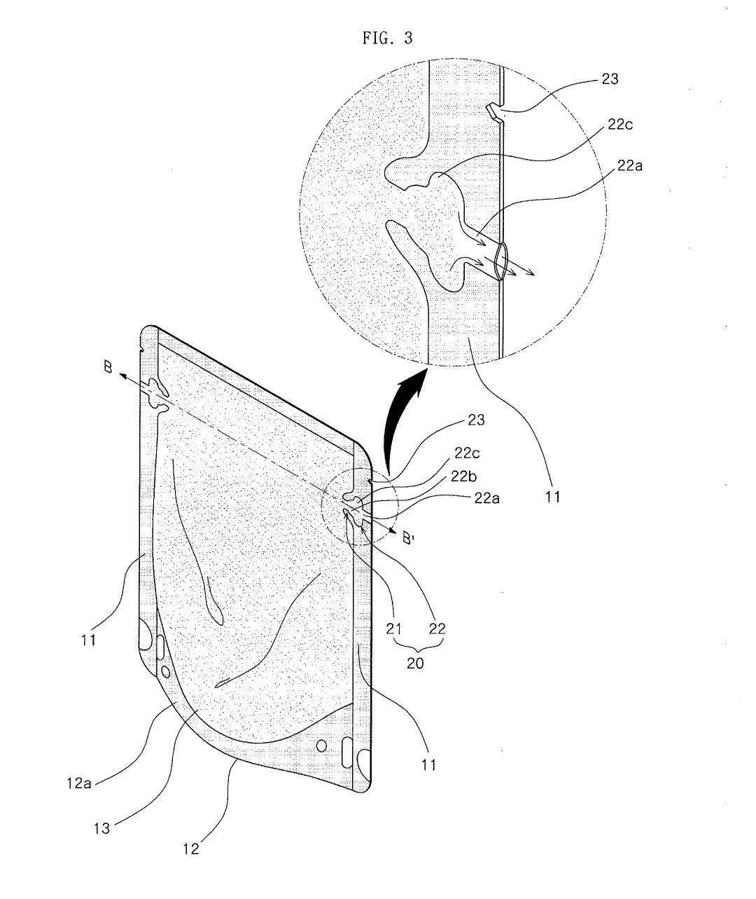

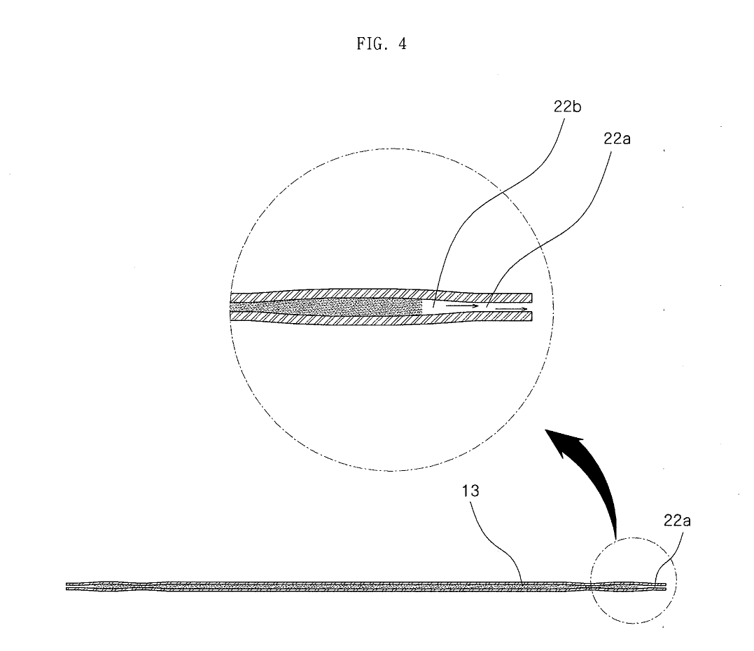

According to the pouch equipped with the internal pressure discharge unit having the above structure usable in the microwave oven, as shown in FIGS. 3 and 4, when it is necessary to discharge the internal pressure of the content retaining part 13 due to expansion of the pouch caused by heat, the sealing weak part 21 is automatically widened so that the front end of the content holding part 22 is open and the gas and contents are introduced into the content holding part 22, thereby primarily adjusting the internal pressure of the content retaining part 13. In addition, when the discharge of the internal pressure of the content holding part 22 is necessary due to the increase of the internal pressure in the content holding part 22, the gas is automatically discharged through the gas discharge line 22a, so that the internal pressure is secondarily adjusted.

Therefore, the contents can be prevented from being leaked out of the pouch even if the heating time is extended, and the gas can be prevented from being discharged out of the pouch while properly maintaining the internal pressure of the pouch, thereby minimizing evaporation of moisture from the contents.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A pouch for a microwave oven capable of preventing contents from being solidified or leaked out of the pouch by adjusting internal pressure of the pouch, the pouch comprising:
a sealing part formed at a side end of the pouch;
a content retaining part;
a sealing weak part formed at an upper portion of the sealing part such that the sealing weak part is widened by the internal pressure upon expansion of the content retaining part;
a content holding part positioned in line with the sealing weak part at a rear portion of the sealing weak part such that a front end of the content holding part is open when the sealing weak part is widened; and
a gas discharge line formed in the content holding part and communicated with an outer end of the sealing part.

2. The pouch as claimed in claim 1, wherein the sealing weak part extends into the content retaining part in a shape of a half-moon, and the content holding part is formed at a center of the sealing weak part such that the front end of the content holding part is positioned inwardly of a side end line of the content retaining part.

3. The pouch as claimed in claim 1, wherein a first expansion part is formed at a center of the content holding part such that a front end of the first expansion part protrudes outward in a curved shape, and a second expansion part is formed at upper and lower portions of the content holding part such that the second expansion part protrudes outward in a curved shape.
